(19) United States
(12) Patent Application Publication
(10) Pub. No.: US 2014/0015181 A1
(43) Pub. Date: Jan. 16, 2014

(54) OFFSET INDEX WELDING POSITIONER

(71) Applicant: RIMROCK AUTOMATION, INC. dba WOLF ROBOTICS, Fort Collins, CO (US)

(72) Inventors: Kevin Murphy, Fort Collins, CO (US); Joshua R. Neville, Loveland, CO (US); John Schoening, Fort Collins, CO (US)

(21) Appl. No.: 13/927,259

(22) Filed: Jun. 26, 2013

Related U.S. Application Data
(60) Provisional application No. 61/671,002, filed on Jul. 12, 2012.

(51) Int. Cl. B23K 37/04; B23Q 1/03

(52) U.S. Cl. CPC B23K 37/04; B23Q 1/03
USPC 269/9; 29/559

(57) ABSTRACT

Disclosed is a two station positioner for positioning work pieces for mounting and working at the same time. A first arm positioner can be located in a mounting position for mounting a work piece on the first arm positioner, while the other arm positioner is located in a working position, where another work piece can be welded or machined. The first positioning arm, in the mounting position, is sufficiently low to allow workers to mount the work piece without the use of elevated platforms. A pedestal exchange platform can then be indexed to place the first positioning arm with the mounted piece in the working position and the other positioning arm in the mounting position. In this manner, workers can mount work pieces while other work pieces are being worked. In the working position, the positioning arm is rotated on a horizontal axis, which reduces programming complexity for robotic welders or machines.

### CROSS-REFERENCE TO RELATED APPLICATION

This application is based upon and claims priority to U.S. provisional application Ser. No. 61/671,002, filed Jul. 12, 2012, entitled “Offset Index Welding Positioner,” which application is specifically incorporated herein by reference for all that it discloses and teaches.

### BACKGROUND

Automated welding techniques using robotic welders and large positioners have greatly increased the quality of industrial welding. Greater reliability can be provided using automated welding techniques. In addition, the welds can be completed rapidly, without the use of highly paid and highly skilled welders.

In addition, the use of positioners to position a piece for welding has also provided for high quality welds. Welds that are performed when the weld is disposed in a horizontal position allow the weld to properly flow into an opening and properly fill the space in the opening. Large positioners are capable of rotating large pieces into positions, so that horizontal, high quality welds can be performed.

### SUMMARY

An embodiment of the present invention may therefore comprise a two station positioner for positioning work pieces for mounting and working comprising: a pedestal exchange platform having a pedestal mounting surface, a first arm mounting surface that is disposed at a first angle to the pedestal mounting surface, and a second arm mounting surface that is disposed at a second angle to the pedestal mounting surface, the second angle being substantially equal and opposite to the first angle; a first positioning arm assembly disposed on the first mounting surface; a second positioning arm assembly mounted on the second mounting surface; a pedestal having a floor mounting surface that is adapted to mount the pedestal on a floor, and a slanted surface that is slanted at a third angle from the floor mounting surface, the third angle having a magnitude that is equal the first angle and the second angle; a pedestal indexer that rotates the pedestal exchange platform to a first position in which the first positioning arm is in an elevated working position that allows a first work piece mounted on the first positioning arm to be at least partially rotated and worked, the first positioning arm having a first arm pivot for rotating the first positioning arm, the first arm pivot having a first axis that is substantially parallel to the floor mounting surface, and the second positioning arm is in a mounting position which allows workers to mount a second work piece to the second positioning arm at standing height without the use of elevated platforms, and that rotates the pedestal exchange platform to a second position in which the second positioning arm is in the elevated working position, the second positioning arm having a second arm pivot for rotating the second positioning arm, the second arm pivot having a second axis that is substantially parallel to the floor mounting surface, and the first positioning arm is in a mounting position which allows workers to remove the first work piece and mount a third work piece to the first positioning arm at standing height without the use of elevated platforms.

An embodiment of the present invention may further comprise a method of positioning work pieces on a two station positioner for mounting and working comprising: mounting a pedestal exchange platform on a slanted surface of a pedestal, the slanted surface disposed at a third angel to a pedestal mounting surface of the pedestal; placing a first positioning arm on a first arm mounting surface of the pedestal exchange platform, the first arm mounting surface disposed at a first angle to the slanted surface so that the first positioning arm rotates on an axis that is substantially parallel to the pedestal mounting surface when the first positioning arm is in a working position, and tilts the first positioning arm to a mounting height that allows mounting and removal of a work piece at a standing height without the use of elevated platforms when the first positioning arm is in a mounting position; placing a second positioning arm on a second mounting surface of the pedestal exchange platform, the second arm mounting surface disposed at a second angle to the slanted surface that is substantially equal and opposite to the first angle, so that the second positioning arm rotates in an axis that is substantially parallel to the pedestal mounting surface when the second positioning arm is in a working position, and tilts the second positioning arm to a mounting height that allows mounting and removal of a work piece at a standing height without the use of elevated platforms when the second mounting arm is in a mounting position; indexing the first positioning arm and the second positioning arm alternately between the working position and the mounting position so that workers can mount a work piece while another work piece is being worked.

### BRIEF DESCRIPTION OF THE DRAWINGS

FIG. 1 is an isometric view of an embodiment of an offset welding positioner.

FIG. 2 is a left side view of the embodiment of FIG. 1.

FIG. 3 is a top view of the embodiment of FIG. 1.

FIG. 4 is a front view of the embodiment of FIG. 1.

FIG. 5 is another perspective view of the embodiment of FIG. 1.

FIG. 6 is another perspective view of the embodiment of FIG. 1 with an arm in the vertical position.

FIG. 7 is a left side view of the embodiment of FIG. 1 with an arm in a vertical position.

FIG. 8 is a left side view of the embodiment of FIG. 1 with the pedestal pivot rotates by 90 degrees.

### DETAILED DESCRIPTION OF THE EMBODIMENTS

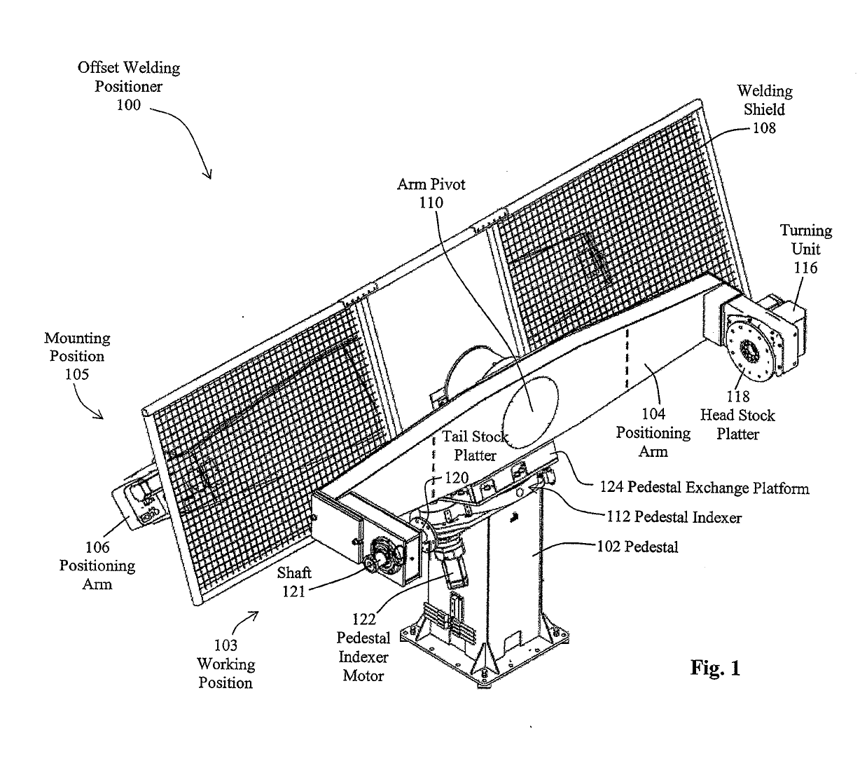

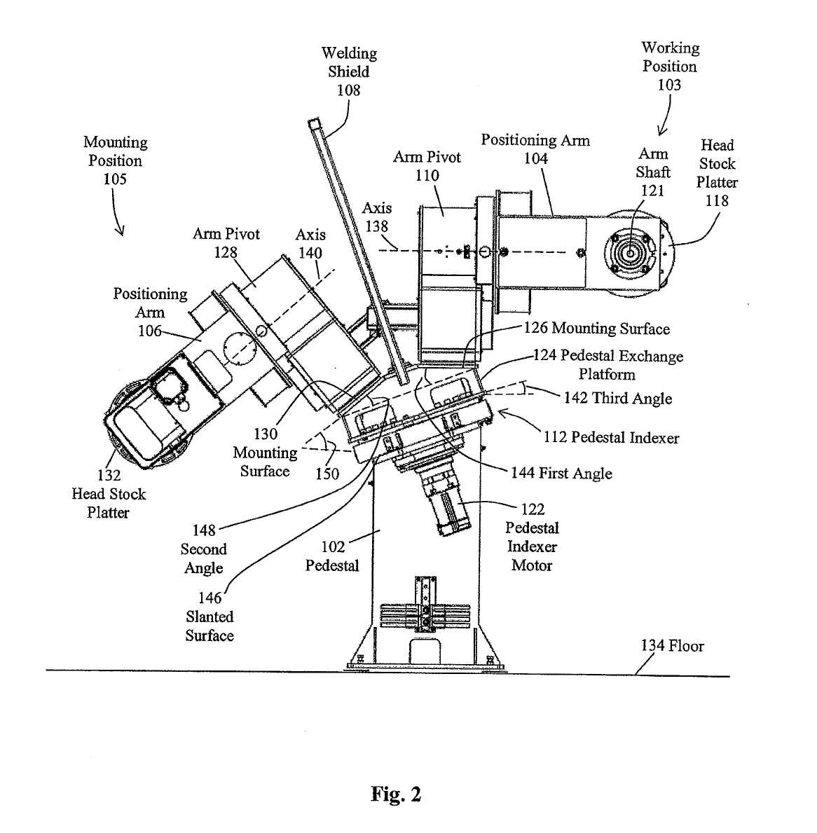

FIG. 1 is an isometric view of an embodiment of an offset welding positioner 100. As illustrated in FIG. 1, the offset welding positioner 100 includes a pedestal 102, having a pedestal indexer 112. The top portion of the pedestal 102 is slanted by a predetermined angle to provide a slanted surface 146 (FIG. 2). In this case, the angle is approximately 20 degrees from horizontal. Other angles can be used to provide a greater or less offset, as explained in more detail below. There are two positioning arm assemblies comprising positioning arm 104 and arm pivot 110 (FIG. 2), and positioning arm 106 and arm pivot 128 (FIG. 2) that are attached to the pedestal indexer 112 at the top of the pedestal 102 on the slanted surface 146. Positioning arm 104 is mounted on an arm pivot 110 that allows the positioning arm 104 to rotate around the arm pivot 110. A similar arm pivot 114 is coupled to the positioning arm 106, as illustrated in FIG. 2. A welding shield 108 is disposed between positioning arm 104 and positioning arm 106 to prevent weld spatters from being transmitted from work pieces disposed on a positioning arm in working position 103. The work piece (not shown) is mounted on head stock platter 118 and tail stock platter 120 of positioning arm 104. A turning unit 116 rotates the work piece on the stock platters 118, 120. Tail stock platter 120 pivots on shaft 121, which rotates on an axis aligned with the axis of the head stock platter 118.

Work pieces for welding and machining are typically lifted into position by a hoist or other device for attachment to stock platters, such as head stock platter 118 and tail stock platter 120. These work pieces can be large and heavy objects that are difficult to position and move to the proper location for attachment to the platters. Additionally, in order to provide sufficient room to rotate the positioning arm, the positioning arm 104 must be located in an elevated working position, such as working position 103, as shown in FIG. 1. In the elevated working position 103 of the positioning arm 104, illustrated in FIG. 1, it is difficult to attach the work piece to the head stock platter 118 and tail stock platter 120. Many times, the positioning arm 104, in the horizontal position illustrated in FIG. 1, is substantially higher than a height at which a person can reach and attach the work piece. In most cases, the users must stand on ladders and raised platforms to attach and detach the work piece. OSHA regulations, in many cases, require that a platform to used rather than ladders. A movable platform for this purpose is expensive. Stairs must be provided on the platform as well as hand rails. In addition, if the platform is over 4 feet high, harnesses that are attached to the platform must be used. This results in an expensive and time consuming process. To solve these problems, the embodiment of FIG. 1 includes a two station positioner 100 that has a working position 103 that is elevated for working and a mounting position 105 that is at a level that allows workers to mount work pieces, while standing on the floor.

FIG. 2 is a left side view of the offset welding positioner 100 of FIG. 1. As illustrated in FIG. 2, the pedestal 102 has a slanted surface 146 to which the pedestal indexer 112 is attached. The pedestal indexer 112 functions to index (rotate) the pedestal exchange platform 124 so that the positioning arms 104, 106 can be rotated to opposite positions, i.e., a working position 103 and a mounting position 105, and vice versa. In other words, for the configuration shown in FIG. 2, positioning arm 106 is located in the mounting position 105 for loading with a work piece (not shown) at a location that is close to the floor 134. The head stock platter 132 is located at a height such that person can guide the work piece on a hoist or other device onto to the head stock platter 132 while standing on floor 134. In this manner, expensive platforms, stairs, hand rails and harnesses are not needed to load the work piece onto the positioning arm 106. The mounting of a work piece on the positioning arm 106 can occur while automated welding or machining is being performed on a different work piece (not shown) that is mounted on positioning arm 104, which is in working position 103. Positioning arm 104 is located above floor 134 by an amount that allows the positioning arm 104 to rotate on the arm pivot 110. The work piece (not shown) on positioning arm 104 is mounted on the head stock platter 118 and can also rotate in an axis defined by shaft 121. As disclosed below, the height of the positioning arm 104 is sufficient to provide clearance so that the positioning arm 104 can be completely rotated by the arm pivot 110 without interference with the floor 134. Welding shield 108 provides protection for workers who are mounting a work piece on the head stock platter 132 while the welding functions are being performed on the work piece that is secured to the positioning arm 104.

An additional feature of the embodiment of welding positioner 100, that is illustrated in FIG. 2, is the unique design of the pedestal exchange platform 124 and the angle of the mounting surfaces 126, 130 that result in the axis 138 of arm pivot 110 being horizontally disposed when the positioning arm 104 is in working position 103, as shown in FIG. 2. The third angle 142 is the angle of the top of the pedestal 102 from horizontal, which is also approximately 20 degrees. Other angles, of course, can be used. The first angle 144 of the mounting surface 126 is the angle at which the mounting surface 126 is disposed relative to the slanted surface 146 of the pedestal 102. Angles 142, 144 are substantially equal so that when the pedestal exchange platform 124 is rotated by the pedestal indexer 112 and pedestal indexer motor 122 to working position 103, as shown in FIG. 2, the mounting surface 126 is substantially horizontal and parallel to floor (pedestal mounting surface) 134. When the pedestal exchange platform 124 is indexed so that positioning arm 104 is located in the mounting position 105, which is the position of positioning arm 106 in FIG. 2, angle 142 and 144 are added together to tilt the positioning arm 104 by twice the angle of the slanted surface 146, such as illustrated in with respect to positioning arm 106 and angle 146. In other words, angle 144 subtracts from angle 142 in working position 103, so that the mounting surface 126 is substantially horizontal. When the positioning arm 104 is indexed by 180 degrees to the mounting position 105, first angle 144 adds to the third angle 142, as shown by positioning arm 106 in FIG. 2.

FIG. 2 illustrates second angle 146, which is the angle between the mounting surface 130 and the slanted surface 146. Angle 150 is the total angle of tilt of the positioning arm 106 in the mounting position shown in FIG. 2. Angle 150 is equal to second angle 148 plus third angle 142 since these angles add together when the pedestal exchange platform 124 locates the positioning arm 106 in the mounting position, as shown in FIG. 2. Since second angle 148 is substantially equal to third angle 142, angle 150 is substantially twice the magnitude of third angle 142. The angle 150 allows the positioning arms 104, 106 to be located in a position that allows users to mount work pieces while standing on the floor 134 and raises the work pieces to a much higher level in working position 103, which allows the positioning arms 104, 106 to rotate in 360 degrees without interfering with the surfaces of the floor 134. Additionally, in working position 103, the third angle 142 of the slanted surface 146 and the angles 144, 148 of mounting surfaces 126, 130, respectively, position the axis 138 of arm pivot 110 and axis 140 of arm pivot 128 in a substantially horizontal position, or a position that is substantially parallel to the pedestal mounting surface, which is the floor 134. An advantage of having the axes 138, 140 in a substantially horizontal or parallel position to the floor 134 is that a welding or machining device that is performing automated or robotic welding or machining is easier to program since there is no change in the lateral distance of various portions of a work piece from the robotic welder or robotic machining device as the positioning arms 104, 106 rotate on axes 138, 140, respectively. For example, as positioning arm 104 rotates along the axis 138 in response to the arm pivot 110, a work piece mounted on positioning arm 104 is located in a single, vertical plane or a plane that is substantially normal to the mounting surface or floor surface 134. A robotic welder that is mounted on the floor surface can be much more easily programmed to locate positions for welding if the plane of rotation of the positioning arm 104 on axis 138 is vertical, or normal to the surface of the floor 134. If the axis 138 is not substantially parallel to the floor 134 (horizontal), the plane of rotation of the positioning arm 104 will cause the lateral distance between the work piece and the robotic welder to vary as the positioning arm is rotated. This adds an additional degree of programming difficulty in programming a welder to make welds automatically on the work piece.

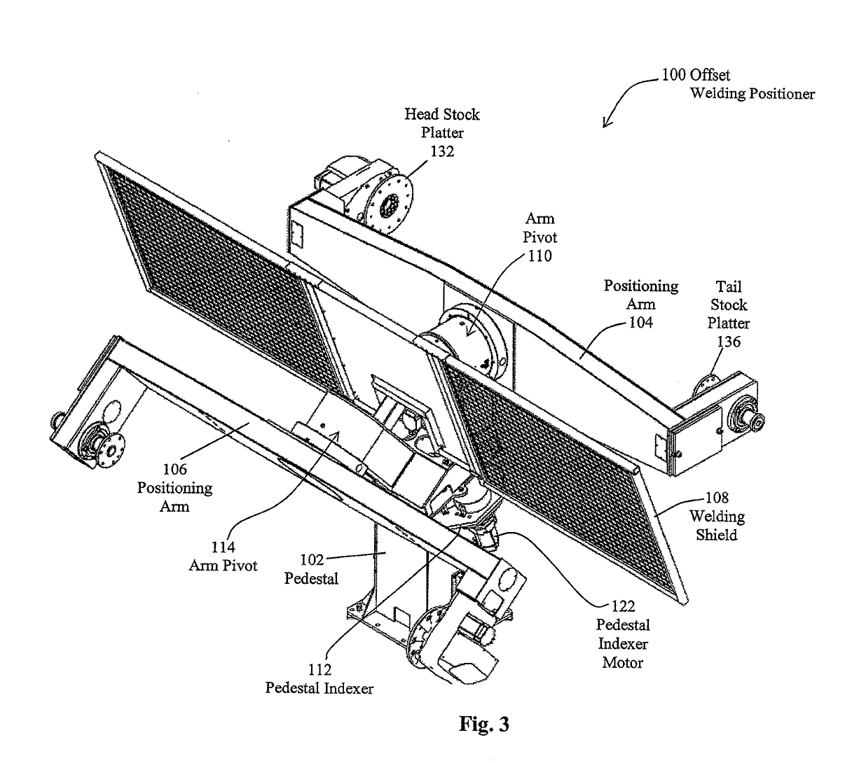

FIG. 3 is another isometric view of the offset welding positioner 100 that corresponds to the embodiments of FIGS. 1 and 2. As illustrated in FIG. 3, the positioning arm 106 is positioned by arm pivot 114 in a horizontal position. Similarly, positioning arm 104 is positioned in a horizontal position on arm pivot 110. Pedestal indexer 112 is located on the pedestal 102. Pedestal indexer 112 cannot be activated by pedestal indexer motor 122 until both positioning arms 104, 106 are disposed in a horizontal position. Welding shield 108 protects a worker who may be mounting a work piece on the positioning arm 106 while welding is being performed by a robot on a work piece that is mounted on positioning arm 104 via head stock platter 132 and tail stock platter 136.

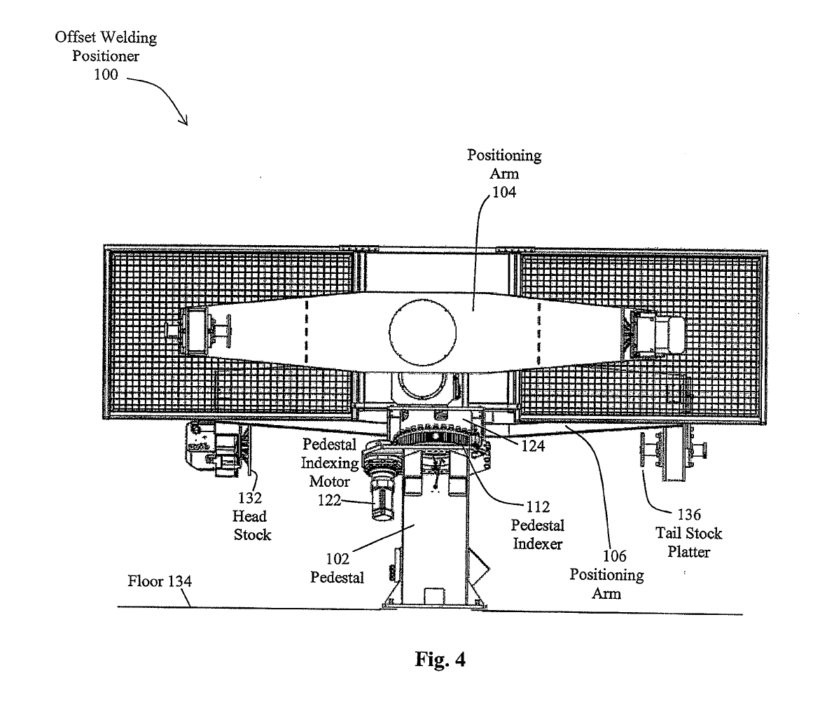

FIG. 4 is a front view of the offset welding positioner 100. As illustrated in FIG. 4, the positioning arm 104 is in a horizontal position. The pedestal indexer motor 122 has rotated the pedestal exchange platform 124 so the positioning arm 104 is in working position 103. Positioning arm 106 is in the mounting position. Pedestal 102 is bolted to the floor 134. A work piece can be mounted on the head stock platter 132 and the tail stock platter 136 while the positioning arm 106 is in the mounting position 105, as shown in FIG. 4.

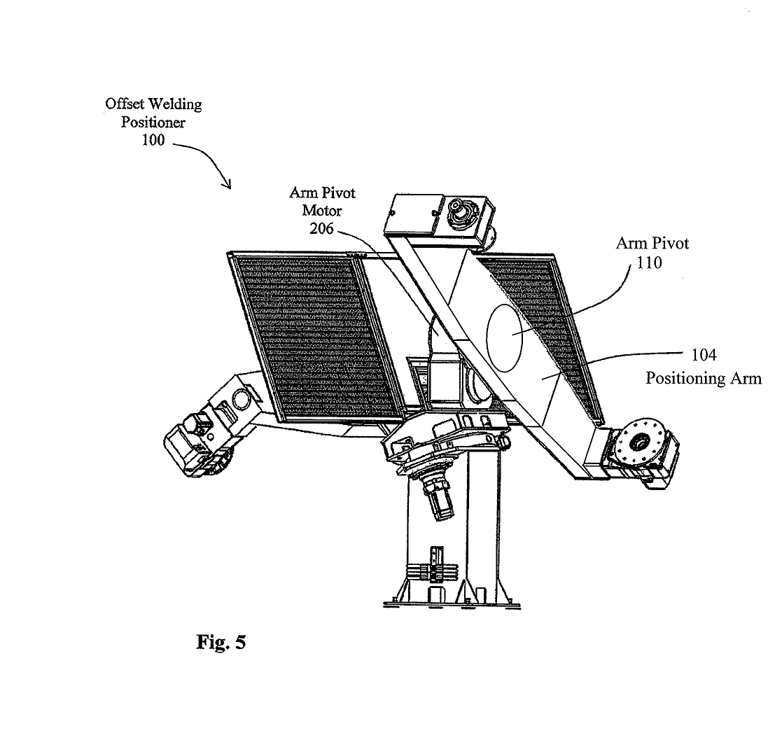

FIG. 5 is an isometric view that illustrates the offset welding positioner 100 with the positioning arm 104 in working position 103 and partially rotated. Positioning arm 104 rotates around the arm pivot 110 and is driven by arm pivot motor 206.

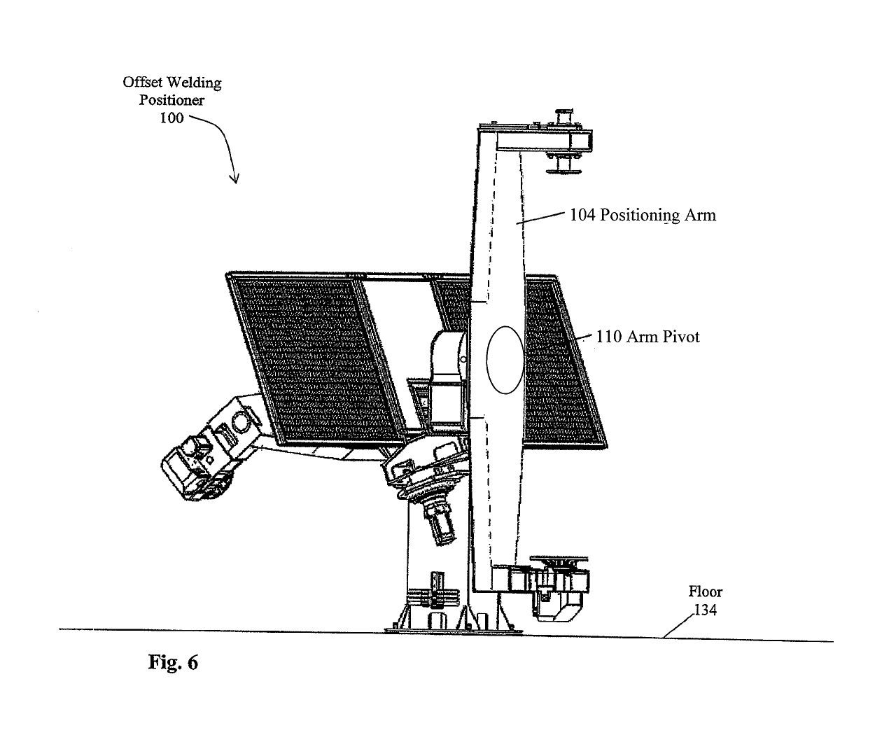

FIG. 6 is an isometric view of the offset welding positioner 100 with the positioning arm 104 rotated to a vertical position. As can be seen in FIG. 6, the positioning arm 104 is in working position 103 and has sufficient clearance to rotate an entire 360 degrees without interfering with the floor 134. The positioning arm 104 rotates around the arm pivot 110, which has a horizontal axis. In this manner, the plane of movement of the rotating positioning arm 104 is vertical.

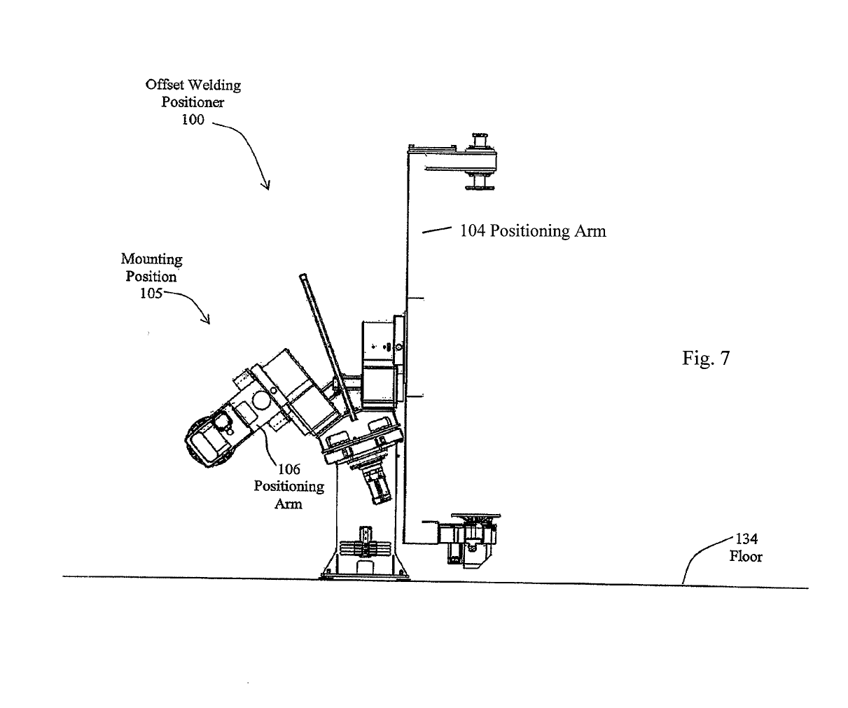

FIG. 7 is a left side view of the embodiment of the offset welding positioner 100 with the positioning arm 104 in a vertical position. Again, the positioning arm 104 has sufficient clearance to avoid interference with the floor 134 and, as such, can rotate an entire 360 degrees. At the same time, positioning arm 106 is in mounting position 105 at a height that allows users to mount work pieces to positioning arm 106 without the use of platforms or ladders.

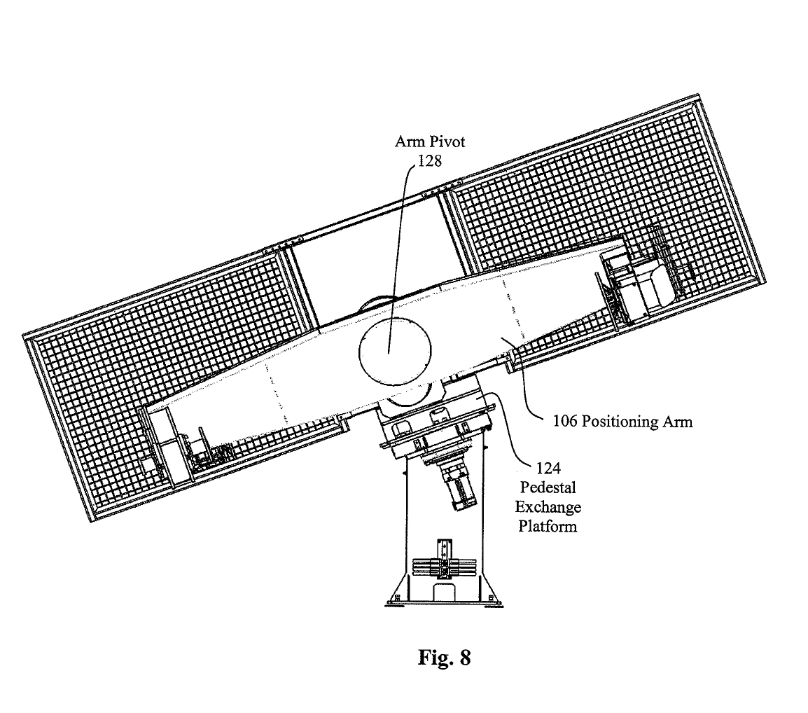

FIG. 8 is a left side view of the offset welding positioner 100 that corresponds to the left side view of FIG. 2, except that the pedestal exchange platform 124 has been indexed by 90 degrees. Positioning arm 106 is being indexed in a counter-clockwise direction viewed from the top from the mounting position 105 to the working position 103. As shown in FIG. 8, the pedestal exchange platform 124 has been rotated or indexed by 90 degrees and will be indexed another 90 degrees until the positioning arm 106 is in the working position 103. At the same time, positioning arm 104 (not shown) is being indexed from the working position 103 to the mounting position 105. When positioning arm 106 is in the working position 103, arm pivot 128 will be horizontal and parallel to the floor 134. Positioning arm 104 will be in the mounting position 105, so that a work piece that has been welded or machined can be removed by workers and replaced with a new work piece.

Hence, the offset welding positioner 100 allows users to mount work pieces in a mounting position 105 at a height that does not require the use of expensive platforms with stairs, hand railings and harnesses. Further, the work pieces are indexed to a working position 103, so that rotation of the positioning arm does not interfere with the floor and maintains a substantially lateral distance from a robotic welder as the positioning arm is rotated. As such, complex programming to program a robotic welder is not required.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A two station positioner for positioning work pieces for mounting and working comprising:
a pedestal exchange platform having a pedestal mounting surface, a first arm mounting surface that is disposed at a first angle to said pedestal mounting surface, and a second arm mounting surface that is disposed at a second angle to said pedestal mounting surface, said second angle being substantially equal and opposite to said first angle;
a first positioning arm assembly disposed on said first mounting surface;
a second positioning arm assembly mounted on said second mounting surface;
a pedestal having a floor mounting surface that is adapted to mount said pedestal on a floor, and a slanted surface that is slanted at a third angle from said floor mounting surface, said third angle having a magnitude that is substantially equal said first angle and said second angle;
a pedestal indexer that rotates said pedestal exchange platform to a first position in which said first positioning arm is in an elevated working position that allows a first work piece mounted on said first positioning arm to be at least partially rotated and worked, said first positioning arm having a first arm pivot for rotating said first positioning arm, said first arm pivot having a first axis that is substantially parallel to said floor mounting surface, and said second positioning arm is in a mounting position which allows workers to mount a second work piece to said second positioning arm at standing height without the use of elevated platforms, and that rotates said pedestal exchange platform to a second position in which said second positioning arm is in said elevated working position, said second positioning arm having a second arm pivot for rotating said second positioning arm, said second arm pivot having a second axis that is substantially parallel to said floor mounting surface, and said first positioning arm is in a mounting position which allows workers to remove said first work piece and mount a third work piece to said first positioning arm at standing height without the use of elevated platforms.

2. The positioner of claim 1 further comprising:
a welding shield mounted between said first positioning arm and said second positioning arm.

3. The positioner of claim 2 wherein said pedestal indexer comprises a pedestal pivot motor for indexing said pivot platform.

4. A method of positioning work pieces on a two station positioner for mounting and working comprising:
mounting a pedestal exchange platform on a slanted surface of a pedestal, said slanted surface disposed at a third angel to a pedestal mounting surface of said pedestal;
placing a first positioning arm on a first arm mounting surface of said pedestal exchange platform, said first arm mounting surface disposed at a first angle to said slanted surface so that said first positioning arm rotates on an axis that is substantially parallel to said pedestal mounting surface when said first positioning arm is in a working position, and tilts said first positioning arm to a mounting height that allows mounting and removal of a work piece at a standing height without the use of elevated platforms when said first positioning arm is in a mounting position;
placing a second positioning arm on a second mounting surface of said pedestal exchange platform, said second arm mounting surface disposed at a second angle to said slanted surface that is substantially equal and opposite to said first angle, so that said second positioning arm rotates in an axis that is substantially parallel to said pedestal mounting surface when said second positioning arm is in a working position, and tilts said second positioning arm to a mounting height that allows mounting and removal of a work piece at a standing height without the use of elevated platforms when said second mounting arm is in a mounting position;
indexing said first positioning arm and said second positioning arm alternately between said working position and said mounting position so that workers can mount a work piece while another work piece is being worked.

5. The method of claim 4 wherein said first angle, said second angle and said third angle are all substantially equal in magnitude.

6. The method of claim 5 wherein said first angle, said second angle and said third angle have a sufficient magnitude to elevate said first positioning arm and said second positioning arm to a height that allows said first positioning arm and said second positioning arm to fully rotate in said working position without interference with said pedestal mounting surface.

7. The method of claim 6 wherein said process of indexing said first positioning arm and said second positioning arm comprises using a pedestal pivot motor.
